(19) United States
(12) Patent Application Publication
(10) Pub. No.: US 2017/0102579 A1
(43) Pub. Date: Apr. 13, 2017

(54) LIQUID CRYSTAL DISPLAY PANEL AND LIQUID CRYSTAL DISPLAY DEVICE

(71) Applicant: Wuhan China Star Optoelectronics Technology Co., Ltd, Wuhan, Hubei (CN)

(72) Inventor: Jiangfeng Wang, Wuhan, Hubei (CN)

(73) Assignee: Wuhan China Star Optoelectronics Technology Co., Ltd, Wuhan, Hubei (CN)

(21) Appl. No.: 14/778,149

(22) PCT Filed: May 6, 2015
(86) PCT No.: PCT/CN2015/078374

§ 371 Date: Nov. 23, 2016

(30) Foreign Application Priority Data
Apr. 24, 2015 (CN) 201510201024.8

(51) Int. Cl. G02F 1/1335

(52) U.S. Cl. CPC G02F 1/133514; G02F 1/133512; G02F 1/133621; G02F 2001/133302

(57) ABSTRACT

According to the present disclosure, the liquid crystal display panel comprises an upper glass substrate, a lower glass substrate, and a blue backlight source. The upper glass substrate comprises a plurality of color-resist units, each color-resist unit comprising a red color-resist region, a green color-resist region, and a transparent region that are arranged spaced from one another, black matrixes that are arranged between each two adjacent regions, and first optical filter layers that are arranged on an outer surface of the upper glass substrate at positions corresponding to the red color-resist region and the green color-resist region. The lower glass substrate comprises second optical filter layers at positions corresponding to the red color-resist region and the green color-resist region. According to the present disclosure, the image display quality of the liquid crystal display panel can be further improved.

### CROSS REFERENCE TO RELATED APPLICATION

The present application claims the priority of Chinese patent application CN 201510201024.8, entitled “Liquid Crystal Display Panel and Liquid Crystal Display Device” and filed on Apr. 24, 2015, the entirety of which is incorporated herein by reference.

### FIELD OF THE INVENTION

The present disclosure relates to the technical field of liquid crystal display, and particularly to a liquid crystal display panel and a liquid crystal display device.

### BACKROUND OF THE INVENTION

In one kind of liquid crystal display device in the prior art, color filters are provided on a liquid crystal display panel, so that images can be displayed. In this kind of liquid crystal display device, a white Light-Emitting Diode (LED) generally serves as a light source thereof. When white light irradiates the color filters in the liquid crystal display panel, only red light, green light, and blue light can transmit through color filters with red color, green color and blue color respectively. At the same time, light of other colors different from that of a color filter would be absorbed by the color filter. As a result, a penetration ratio of the light which is emitted by the white LED and which can transmit through the color filter is less than 30 percent, and thus a large amount of light loss would be generated.

In the other kind of liquid crystal display device in the prior art, a blue LED generally serves as a light source thereof. Red fluorescent powder and green fluorescent powder or quantum dots are used to substitute the red color filter and the green color filter which are used in the first kind of liquid crystal display device and which would absorb relatively more light. In addition, a transparent protection layer is used to substitute the original blue color filer in the first kind of liquid crystal display device. With respect to a region of the transparent protection layer where no fluorescent powder or quantum dot is provided, blue light can transmit therethrough directly. With respect to a region where red fluorescent powder or quantum dots are provided, the red fluorescent powder or quantum dots would be excited by blue light to emit red light. With respect to a region where green fluorescent powder or quantum dots are provided, the green fluorescent powder or quantum dots would be excited by blue light to emit green light. In this case, red light, green light, and blue light obtained therein can superpose with one another, so that colorful images can be displayed. However, in this kind of liquid crystal display device, when blue light irradiates the red fluorescent powder or the green fluorescent powder, it can hardly be absorbed by the fluorescent powder sufficiently, and part of blue light would exit from a light-exiting surface of the glass substrate through the fluorescent powder. As a result, the blue light cannot be utilized fully due to the aforesaid leakage. The blue light that exits from the light-exiting surface of the glass substrate would mix with the red light or the green light that exits from the fluorescent powder with a corresponding color, and consequently, the color gamut display quality and the image display quality of the liquid crystal display panel would both be suffered.

With respect to the aforesaid technical problem, a liquid crystal display panel in which the blue light can be utilized fully is needed, whereby the color gamut display quality and the image display quality of the liquid crystal display panel can both be improved.

### SUMMARY OF THE INVENTION

With respect to the technical defect in the prior art, the present disclosure provides a novel liquid crystal display panel and a liquid crystal display device comprising the display panel.

The present disclosure provides a liquid crystal display panel, which comprises an upper glass substrate and a lower glass substrate that are arranged opposite to each other, and a backlight source that is arranged below the lower glass substrate and used for emitting blue light. The upper glass substrate comprises a plurality of color-resist units that are arranged on an inner surface of the upper glass substrate, each color-resist unit comprising a red color-resist region, a green color-resist region, and a transparent region that are arranged spaced from one another. The upper glass substrate further comprises black matrixes that are arranged between each two adjacent regions, and first optical filter layers that are arranged on an outer surface of the upper glass substrate at positions corresponding to the red color-resist region and the green color-resist region. The lower glass substrate comprises second optical filter layers at positions corresponding to the red color-resist region and the green color-resist region.

According to the present disclosure, the upper glass substrate and the lower glass substrate are provided with the first optical filter layers and the second optical filter layers respectively at positions corresponding to the red color-resist region and the green color-resist region, so that the blue light that is emitted by the backlight source can be prevented from exiting from the upper glass substrate through color-resist regions thereof with the cooperation of the first optical filter layers and the second optical filter layers. In this case, only light with a color the same as that of a color-resist region can exit from said color-resist region, and the light which exits from the color-resist region with a corresponding color can mix with the blue light which exits from the transparent region directly so as to form white light for image displaying. Compared with the traditional display panel, in the display panel according to the present disclosure, no blue light can exit from the color-resist region of the upper glass substrate, so that the utilization ratio of the blue light can be improved, and thus the color gamut display quality and the image display quality of the liquid crystal display panel can both be improved.

According to some embodiments, each first optical filter layer is arranged so that light of a color the same as a color of a corresponding color-resist region can transmit through the first optical filter layer, while light of other colors different from the color of the corresponding color-resist region can be reflected by the first optical filter layer; and each second optical filter layer is arranged so that light of a color the same as a color of a corresponding color-resist region can be reflected by the second optical filter layer, while light of other colors different from the color of the corresponding color-resist region can transmit through the second optical filter layer.

According to the embodiment, when the blue light that is emitted by the backlight source irradiates the red color-resist region through the second optical filter layer, the red color-resist region can be excited by the blue light to emit red light, which would exit from the upper glass substrate through the first optical filter layer. At the same time, the blue light would be reflected by the first optical filter layer. During this procedure, the red color-resist region would further be excited by the reflected blue light to emit red light, and then part of the blue light and the red light can mix with each other and then irradiate the second optical filter layer. The blue light can transmit through the second optical filter layer while the red light can be reflected by the second optical filter layer to the first optical filter layer. Therefore, the blue light which transmits through the second optical filter layer can be utilized by the backlight source once again, and the reflected red light would exit from the upper glass substrate through the first optical filter layer. Similarly, when the blue light irradiates the green color-resist region, the light transmission principle thereof is the same as that when the blue light irradiates the red color-resist region. With respect to the transparent region, the blue light can transmit through the upper glass substrate directly. The blue light, red light, and green light, which all exit from the upper glass substrate, can mix with one another so as to form white light for image displaying.

According to some embodiments, a light transmission area of the first optical filter layer is larger than or equal to that of a corresponding color-resist region, and a light transmission area of the second optical filter layer is larger than or equal to that of a corresponding color-resist region. With this arrangement, the light which enters into each color-resist region can transmit through the first optical filter layer and the second optical filter layer or be reflected by the first optical filter layer and the second optical filter layer sufficiently, so that the leakage of blue light can be further prevented, and the display quality of the images can be further improved.

According to some embodiments, the red color-resist region and the green color-resist region are provided with a red fluorescent layer and a green fluorescent layer respectively, and the transparent region is provided with a transparent layer with a thickness the same as that of the red fluorescent layer and the green fluorescent layer. According to the embodiment, the fluorescent layer with a particular color can be excited by blue light to emit light with a corresponding color, so that images can be displayed. The fluorescent layer and the transparent layer are arranged with the same thickness, so that the upper glass substrate can have a flat surface, and the stability and reliability of the structure of the upper glass substrate can be ensured.

According to some embodiments, the red color-resist region and the green color-resist region are provided with a first quantum dot layer and a second quantum dot layer respectively, and the transparent region is provided with a transparent layer with a thickness the same as that of the first quantum dot layer and the second quantum dot layer. Preferably, the first quantum dot layer at least comprises quantum dots that can be emitted by blue light to emit red light, and the second quantum dot layer at least comprises quantum dots that can be emitted by blue light to emit green light. According to the embodiment, the first quantum dot layer and the second quantum dot layer can be excited by blue light to emit light with a corresponding color, so that images can be displayed. Similarly, the first quantum dot layer, the second quantum dot layer, and the transparent layer can have the same thickness, so that the upper glass substrate can have a flat surface, and the stability and reliability of the structure of the upper glass substrate can be ensured.

According to some embodiments, the first optical filter layer and the second optical filter layer are made of a plurality of different transparent material layers in a laminated manner respectively. The first optical filter layer and the second optical filter layer can have different transmission properties or reflection properties through controlling a quantity of the transparent material layers, a thickness of each layer and a laminated mode thereof. That is, light of different wave bands can transmit through the layer or be reflected by the layer. In this manner, the optical filter layer can cooperate with the corresponding color-resist, so that light can transmit therethrough or be reflected.

According to some embodiments, the transparent material layer is preferably made of one or more selected from a group consisting of SiO₂, TiO₂, and MgF₂.

According to some embodiments, the black matrix is provided with a reflection layer on a surface thereof. Since the reflection layer is provided therein, on the one hand, the light can be prevented from being absorbed by the black matrix, and on the other hand, the light can be reflected to the backlight source as much as possible. Therefore, the light utilization ratio of the backlight source can be significantly improved.

The present disclosure further provides a liquid crystal display device, which comprises the aforesaid liquid crystal display panel.

Compared with the prior art, in the liquid crystal display panel according to the present disclosure, no blue light can exit from the color-resist regions of the upper glass substrate with the cooperation of the first optical filter layer and the second optical filter layer. Therefore, the utilization ratio of the blue light can be improved, and thus the color gamut display quality and the image display quality of the liquid crystal display panel can both be improved. Moreover, according to the present disclosure, since the black matrix is provided with the reflection layer on the surface thereof, the light utilization ratio can be further improved while the color gamut display quality and the image display quality of the liquid crystal display panel would not be affected.

### BRIEF DESCRIPTION OF THE DRAWINGS

The present disclosure will be illustrated in detail hereinafter with reference to the embodiments and the drawing. In the drawing:

FIG. 1 schematically shows a structure of a liquid crystal display panel according to the present disclosure.

In the drawing, a same component is represented by a same reference sign. The drawing is not drawn according to actual scale.

### DETAILED DESCRIPTION OF THE EMBODIMENTS

The present disclosure will be further illustrated hereinafter with reference to the drawings.

The details described herein are only specific examples used for discussing the implementations of the present disclosure. The most useful and most understandable description on the principle and concept of the present disclosure is provided. The structural details which go beyond the scope of basic understanding of the present disclosure are not provided herein. Therefore, those skilled in the art can clearly understand, based on the description and the accompanying drawings, how to implement the present disclosure in different ways.

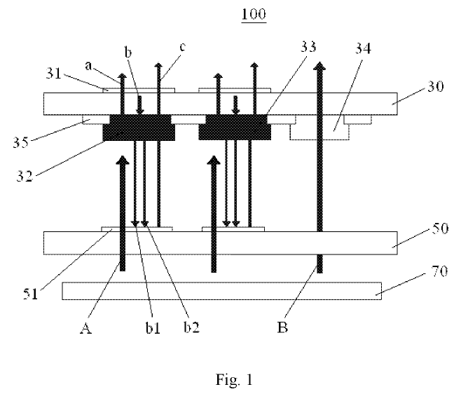

FIG. 1 schematically shows a structure of a liquid crystal display panel 100 according to the present disclosure. The liquid crystal display panel 100 comprises an upper glass substrate 30 and a lower glass substrate 50 that are arranged opposite to each other, and a backlight source 70 that is arranged below the lower glass substrate 50 and used for emitting blue light. The upper glass substrate 30 comprises a plurality of color-resist units that are arranged on an inner surface of the upper glass substrate 30, each color-resist unit comprising a red color-resist region 32, a green color-resist region 33, and a transparent region 34 that are arranged spaced from one another. The upper glass substrate 30 further comprises black matrixes 35 that are arranged between each two adjacent regions, and first optical filter layers 31 that are arranged on an outer surface of the upper glass substrate 30 at positions corresponding to the red color-resist region 32 and the green color-resist region 33. The lower glass substrate 50 comprises second optical filter layers 51 at positions corresponding to the red color-resist region 32 and the green color-resist region 33. It should be noted that, only one single first optical filter layer 31 is indicated in FIG. 1 as an example, and only one single second optical filter layer 51 is indicated in FIG. 1 as an example. The “inner surface” mentioned according to the present disclosure specifically refers to inside surfaces of a region that is formed by the upper glass substrate 30 and the lower glass substrate 50.

According to the present disclosure, the upper glass substrate 30 and the lower glass substrate 50 are provided with the first optical filter layers 31 and the second optical filter layers 51 respectively at positions corresponding to the red color-resist region 32 and the green color-resist region 33, so that the blue light that is emitted by the backlight source 70 can be prevented from exiting from the upper glass substrate 30 through color-resist regions thereof with the cooperation of the first optical filter layers 31 and the second optical filter layers 51. In this case, only light with a color the same as that of a color-resist region can exit from said color-resist region, and the light which exits from the color-resist region with a corresponding color can mix with the blue light which exits from the transparent region 34 directly so as to form white light for image displaying. Compared with the traditional display panel, in the display panel according to the present disclosure, no blue light can exit from the color-resist region of the upper glass substrate 30, so that the utilization ratio of the blue light can be improved, and thus the color gamut display quality and the image display quality of the liquid crystal display panel can both be improved.

According to the embodiment as shown in FIG. 1, each first optical filter layer 31 is arranged so that light of a color the same as a color of a corresponding color-resist region can transmit through the first optical filter layer 31, while light of other colors different from the color of the corresponding color-resist region can be reflected by the first optical filter layer 31; and each second optical filter layer 51 is arranged so that light of a color the same as a color of a corresponding color-resist region can be reflected by the second optical filter layer 51, while light of other colors different from the color of the corresponding color-resist region can transmit through the second optical filter layer 51.

According to the present embodiment, when the blue light A that is emitted by the backlight source 70 irradiates the red color-resist region 32 through the second optical filter layer 51, the red color-resist region 32 can be excited by the blue light A to emit red light a, which would exit from the upper glass substrate 30 through the first optical filter layer 31. At the same time, the blue light b would be reflected by the first optical filter layer 31. During this procedure, the red color-resist region 32 would further be excited by the reflected blue light b to emit red light b2, and then part of the blue light b1 and the red light b2 can mix with each other and then irradiate the second optical filter layer 51. The blue light b1 can transmit through the second optical filter layer 51 while the red light b2 can be reflected by the second optical filter layer 51 to the first optical filter layer 31 and then forms red light c. Therefore, the blue light b1 which transmits through the second optical filter layer 51 can be utilized by the backlight source 70 once again, and the reflected red light c would exit from the upper glass substrate 30 through the first optical filter layer 31. Similarly, when the blue light irradiates the green color-resist region 33, the light transmission principle thereof is the same as that when the blue light irradiates the red color-resist region 32, and the details of which are no longer repeated here. With respect to the transparent region 34, the blue light B can transmit through the upper glass substrate 30 directly. The blue light, red light, and green light, which all exit from the upper glass substrate 30, can mix with one another so as to form white light for image displaying.

Preferably, a light transmission area of the first optical filter layer 31 is larger than or equal to that of a corresponding color-resist region, and a light transmission area of the second optical filter layer 51 is larger than or equal to that of a corresponding color-resist region. With this arrangement, the light which enters into each color-resist region can transmit through the first optical filter layer 31 and the second optical filter layer 51 or be reflected by the first optical filter layer 31 and the second optical filter layer 51 sufficiently, so that the leakage of blue light can be further prevented, the loss of blue light can be avoided, and the display quality of the images can be further improved.

According to the present disclosure, each color-resist region can be coated with a fluorescent layer with a corresponding color, or a quantum dot layer that can be excited to emit light with a corresponding color. For example, according to the embodiment as shown in FIG. 1, the red color-resist region 32 and the green color-resist region 33 are provided with a fluorescent layer with a corresponding color respectively, and the transparent region 34 is provided with a transparent layer with a thickness the same as that of the fluorescent layer. According to the embodiment, the fluorescent layer with a particular color can be excited by blue light to emit light with a corresponding color, so that images can be displayed. The fluorescent layer and the transparent layer are arranged with the same thickness, so that the upper glass substrate can have a flat surface, and the stability and reliability of the structure of the upper glass substrate can be ensured.

Alternatively, the red color-resist region 32 and the green color-resist region 33 can be provided with a first quantum dot layer and a second quantum dot layer respectively, and the transparent region 34 can be provided with a transparent layer with a thickness the same as that of the first quantum dot layer and the second quantum dot layer. Preferably, the first quantum dot layer at least comprises quantum dots that can be emitted by blue light to emit red light, and the second quantum dot layer at least comprises quantum dots that can be emitted by blue light to emit green light. According to the embodiment, the first quantum dot layer and the second quantum dot layer can be excited by blue light to emit light with a corresponding color, so that images can be displayed. Similarly, the first quantum dot layer, the second quantum dot layer, and the transparent layer can have the same thickness, so that the upper glass substrate 30 can have a flat inner surface, and the stability and reliability of the structure of the upper glass substrate can be ensured.

According to the present disclosure, the first optical filter layer 31 and the second optical filter layer 51 are made of a plurality of different transparent material layers in a laminated manner respectively. The first optical filter layer 31 and the second optical filter layer 51 can have different transmission properties or reflection properties through controlling a quantity of the transparent material layers, a thickness of each layer and a laminated mode thereof. That is, light of different wave bands can transmit through the layer or be reflected by the layer. In this manner, the optical filter layer can cooperate with the corresponding color-resist, so that light can transmit therethrough or be reflected. Preferably, the transparent material layer is made of one or more selected from a group consisting of SiO₂, TiO₂, and MgF₂.

In addition, according to the present disclosure, the black matrix 35 is provided with a reflection layer on a surface thereof. Since the reflection layer is provided therein, on the one hand, the light can be prevented from being absorbed by the black matrix 35, and on the other hand, the light can be reflected to the backlight source 70 as much as possible. Therefore, the light utilization ratio of the backlight source 70 can be significantly improved. The reflection layer is preferably a metal layer. The metal layer can be coated on the surface of the black matrix 35 directly, and the processing thereof is simple.

The present disclosure further provides a liquid crystal display device, which comprises the aforesaid liquid crystal display panel 100. Other structures of the liquid crystal display device can be arranged the same as or similar to those of the traditional display device, and the operation principle thereof is well known to those skilled in the art. The details of which are no longer repeated here.

It should be noted that, the above embodiments are described only for better understanding, rather than restricting the present disclosure. Those skilled in the art can make amendments to the present disclosure within the scope as defined in the claims and without departing from the spirit and scope of the present disclosure. The present disclosure is described according to specific methods, materials, and implementations, but the present disclosure is not restricted by the details disclosed herein. On the contrary, the present disclosure is applicable for the equivalent structures, methods, and applications with the same functions as those defined in the claims.

1. A liquid crystal display panel, comprising an upper glass substrate and a lower glass substrate that are arranged opposite to each other, and a backlight source that is arranged below the lower glass substrate and used for emitting blue light,
wherein the upper glass substrate comprises:
a plurality of color-resist units that are arranged on an inner surface of the upper glass substrate, each color-resist unit comprising a red color-resist region, a green color-resist region, and a transparent region that are arranged spaced from one another;
black matrixes that are arranged between each two adjacent regions; and
first optical filter layers that are arranged on an outer surface of the upper glass substrate at positions corresponding to the red color-resist region and the green color-resist region; and
wherein the lower glass substrate comprises second optical filter layers at positions corresponding to the red color-resist region and the green color-resist region.

2. The liquid crystal display panel according to claim 1, wherein each first optical filter layer is arranged so that light of a color the same as a color of a corresponding color-resist region can transmit through the first optical filter layer, while light of other colors different from the color of the corresponding color-resist region can be reflected by the first optical filter layer; and
wherein each second optical filter layer is arranged so that light of a color the same as a color of a corresponding color-resist region can be reflected by the second optical filter layer, while light of other colors different from the color of the corresponding color-resist region can transmit through the second optical filter layer.

3. The liquid crystal display panel according to claim 2, wherein a light transmission area of the first optical filter layer is larger than or equal to that of a corresponding color-resist region, and a light transmission area of the second optical filter layer is larger than or equal to that of a corresponding color-resist region.

4. The liquid crystal display panel according to claim 1, wherein a light transmission area of the first optical filter layer is larger than or equal to that of a corresponding color-resist region, and a light transmission area of the second optical filter layer is larger than or equal to that of a corresponding color-resist region.

5. The liquid crystal display panel according to claim 1, wherein the red color-resist region and the green color-resist region are provided with a red fluorescent layer and a green fluorescent layer respectively, and the transparent region is provided with a transparent layer with a thickness the same as that of the red fluorescent layer and the green fluorescent layer.

6. The liquid crystal display panel according to claim 2, wherein the red color-resist region and the green color-resist region are provided with a red fluorescent layer and a green fluorescent layer respectively, and the transparent region is provided with a transparent layer with a thickness the same as that of the red fluorescent layer and the green fluorescent layer.

7. The liquid crystal display panel according to claim 1, wherein the red color-resist region and the green color-resist region are provided with a first quantum dot layer and a second quantum dot layer respectively, and the transparent region is provided with a transparent layer with a thickness the same as that of the first quantum dot layer and the second quantum dot layer.

8. The liquid crystal display panel according to claim 7, wherein the first quantum dot layer at least comprises quantum dots that can be emitted by blue light to emit red light, and the second quantum dot layer at least comprises quantum dots that can be emitted by blue light to emit green light.

9. The liquid crystal display panel according to claim 2, wherein the red color-resist region and the green color-resist region are provided with a first quantum dot layer and a second quantum dot layer respectively, and the transparent region is provided with a transparent layer with a thickness the same as that of the first quantum dot layer and the second quantum dot layer.

10. The liquid crystal display panel according to claim 9, wherein the first quantum dot layer at least comprises quantum dots that can be emitted by blue light to emit red light, and the second quantum dot layer at least comprises quantum dots that can be emitted by blue light to emit green light.

11. The liquid crystal display panel according to claim 1, wherein the first optical filter layer and the second optical filter layer are made of a plurality of different transparent material layers in a laminated manner respectively.

12. The liquid crystal display panel according to claim 11, wherein the transparent material layer is made of one or more selected from a group consisting of SiO₂, TiO₂, and MgF₂.

13. The liquid crystal display panel according to claim 1, wherein the black matrix is provided with a reflection layer on a surface thereof.

14. A liquid crystal display device, comprising a liquid crystal display panel, which comprises an upper glass substrate and a lower glass substrate that are arranged opposite to each other, and a backlight source that is arranged below the lower glass substrate and used for emitting blue light,
wherein the upper glass substrate comprises:
a plurality of color-resist units that are arranged on an inner surface of the upper glass substrate, each color-resist unit comprising a red color-resist region, a green color-resist region, and a transparent region that are arranged spaced from one another;
black matrixes that are arranged between each two adjacent regions; and
first optical filter layers that are arranged on an outer surface of the upper glass substrate at positions corresponding to the red color-resist region and the green color-resist region; and
wherein the lower glass substrate comprises second optical filter layers at positions corresponding to the red color-resist region and the green color-resist region.

15. The liquid crystal display device according to claim 14, wherein each first optical filter layer is arranged so that light of a color the same as a color of a corresponding color-resist region can transmit through the first optical filter layer, while light of other colors different from the color of the corresponding color-resist region can be reflected by the first optical filter layer; and
wherein each second optical filter layer is arranged so that light of a color the same as a color of a corresponding color-resist region can be reflected by the second optical filter layer, while light of other colors different from the color of the corresponding color-resist region can transmit through the second optical filter layer.

16. The liquid crystal display device according to claim 14, wherein a light transmission area of the first optical filter layer is larger than or equal to that of a corresponding color-resist region, and a light transmission area of the second optical filter layer is larger than or equal to that of a corresponding color-resist region.

17. The liquid crystal display device according to claim 14, wherein the red color-resist region and the green color-resist region are provided with a red fluorescent layer and a green fluorescent layer respectively, and the transparent region is provided with a transparent layer with a thickness the same as that of the red fluorescent layer and the green fluorescent layer.

18. The liquid crystal display device according to claim 14, wherein the red color-resist region and the green color-resist region are provided with a first quantum dot layer and a second quantum dot layer respectively, and the transparent region is provided with a transparent layer with a thickness the same as that of the first quantum dot layer and the second quantum dot layer.

19. The liquid crystal display device according to claim 18, wherein the first quantum dot layer at least comprises quantum dots that can be emitted by blue light to emit red light, and the second quantum dot layer at least comprises quantum dots that can be emitted by blue light to emit green light.

20. The liquid crystal display device according to claim 14, wherein the first optical filter layer and the second optical filter layer are made of a plurality of different transparent material layers in a laminated manner respectively.
